(19) United States
(12) Patent Application Publication
(10) Pub. No.: US 2008/0154728 A1
(43) Pub. Date: Jun. 26, 2008

(54) System and method for identifying and selling terrestrial large format advertisements viewable by air travelers and satellites in specific geographic markets

(76) Inventor: Gregory A. Thomas, La Jolla, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/004,272

(22) Filed: Dec. 19, 2007

Related U.S. Application Data
(60) Provisional application No. 60/876,955, filed on Dec. 23, 2006.

(51) Int. Cl. G09F 19/22

(52) U.S. Cl. 705/14

(57) ABSTRACT

A method of identifying, cataloging, and providing advertising space for advertising indica viewable by aircraft passengers approaching airports. Planar space located along approach and departure vectors at specific airports, which is ascertained to be viewable by passengers landing and taking off from the identified airport, is cataloged for size. A database of individual planar surfaces so identified is thereafter matched to advertising copy requirements of advertisers and leased for placement of advertisement copy. Also identified and cataloged are large planar surfaces viewable from satellites by internet users following a popular terrestrial path.

This application claims the benefit of U.S. Provisional Application No. 60/876,955 filed Dec. 23, 2006, and incorporated herein in its entirety by reference.

### FIELD OF THE INVENTION

The disclosed system and method relates generally to outdoor or out of home advertising. More particularly, the system relates to a system for identifying terrestrial large format advertising locations which are viewable by airline passengers entering and departing specific geographic locations adjacent to airports. The method involves identifying individual planar surfaces adapted to large format indica advertising located on rooftops and angled walls and surfaces visible along airport runway approach and departure flight paths, and selling advertisements for indicia to be located on appropriately dimensioned identified surfaces to advertisers seeking to locate ads directed at airline passengers entering or leaving a specific geographic market.

### BACKGROUND OF THE INVENTION

Large format outdoor advertising such as billboards in the United States have been under ever-increasing restriction due to environmentalists and naturalists seeking increased regulation and removal of large outdoor signage as a blight upon the view from autos in many areas. Cities have also in recent years severely restricted outdoor signage and large format outdoor advertising and also advertising painted upon the sides of buildings within the city limits in an effort to reduce sign blight and improve the aesthetic view of the streets and buildings in the area.

Tourists visiting an area, while being offered unobstructed local views provided by the removal of local vertically oriented large format signage, have also lost a valuable tool that formerly aided their travels to unfamiliar locals and vacation destinations. This is because large format outdoor signage which formerly provided advertising for local vendors and products and venues is no longer available. Consequently, where travelers and local residents could formerly find information about lodging, restaurants, and products on local exterior signage, more recently they are unable to find such information. This void in advertising has left travelers less informed about local highlights and eateries and such and has left vendors for products and services searching for a means to inform travelers of the availability of their products and services.

Accordingly, there is an unmet need for a system to provide large planar surfaces for outdoor advertising of goods and services. Such a system should provide such outdoor advertising in a manner that is not considered visual blight locally and thereby overcomes the aversion to such outdoor advertising that vertical signage has caused in the past.

Such a system should therefore provide such large planar surfaces for outdoor advertisements at an angle that is only viewable from the airspace above. To provide viewing to the maximum number of potential consumers such a system should identify terrestrial locations adapted to large planar signage and advertising that is easily viewable from the cabin of commercial airliners approaching or departing an airport. Such a system should also provide local vendors and national vendors targeted advertising viewable by potential consumers in airliners entering or leaving very specific geographic markets to thereby provide maximum exposure to potential product and service consumers entering or leaving that market. Finally, such a system and method should also be able to ascertain very specific locations by size and viewing angle in relation to the anticipated altitude and downward viewing angle of passengers in landing planes, to match terrestrial viewable locations to the size of indicia in an advertisement which is needed for easy reading or viewing by passengers in planes at different altitudes and speeds during take-off and approach to the individual runways of an airport.

### SUMMARY OF THE INVENTION

The disclosed system and method provides for identification of terrestrial locations viewable from downward looking passengers in airplanes landing in assigned flight paths at local airports. In addition, the system provides a method of local or national advertising to advertising clients wishing to direct advertisements at potential customers entering and leaving individual geographic areas served by an airport having established or assigned approach and departure air routes. Further, the system and method provides for determination of large planar areas generally viewable from above, but not at street level, that can be seen by both airline passengers and internet mapping sites using satellites such as Google Earth.

Controlled airspace is an aviation term used to describe airspace in which traffic levels are such that it has been determined that air traffic control (ATC) must provide some form of separation between aircraft. Controlled airspace usually exists in the immediate vicinity of busier airports, where aircraft used in commercial air transport flights are climbing during a departure or descending during an approach to the airport. By assigning all air traffic into and out of a specific airport, vectors determining assigned flight paths for departure and landing, and consistently requiring air traffic to follow these specific routes, air traffic can be serviced to local airports at higher levels. Some countries (significantly the U.S.) also provide controlled airspace almost generally; however, in most countries it is common to provide uncontrolled airspace in areas where significant air transport or military activity is not expected.

Most large airports in the United States are surrounded by controlled airspace wherein every flight into the airport and departing from the airport must adhere to strict flight paths. While the length of these defined highways in the sky varies, most such controlled airspace into busier airports begins about 30 to 50 nautical miles from the airport, from the ground surface up to about 10,000 feet elevation.

The actual airspace boundaries and altitudes assigned to a terminal control are based on factors such as traffic flow, neighboring airports and terrain, and vary widely from airport to airport. However, the end result is that almost all large airports require specific linear routes be taken for all incoming airplanes from a distance approaching the airport along a vector to the runway. This vectored approach takes every landing plane over the same specific flight path, day in and day out. During a landing, the incoming planes following the vectored path will remain substantially in-line in their approach and will be separated by a certain defined distance in miles. With modern navigation equipment, all the approaching planes will, as such, pass over the same ground space at varying altitudes and descent rates depending on the size of the plane.

Most passengers on approach to an airport tend to look out the windows if possible. With the planes following a predictable path, it is thus possible to place outdoor large format advertising on rooftops and parking lots, and large planar areas viewable at an angle by passengers in airplanes following the assigned flight paths. Once ascertained for proper size and viewing angle, such planar surfaces offer targeted advertising space to airline passengers in specific geographic areas. Further, such identified planar surfaces can also be seen by modern satellites providing local geographic views for internet sites accessed by remote users to view a locale. This allows remote viewers of the geographic locale to see the advertisements as well as incoming and departing passengers.

In a method to determine suitable local placement of outdoor large format advertising, the steps include:

determining the vector for approaching and departing aircraft required or generally assigned at an airport;

identifying individual planar surfaces viewable by passengers from fuselage windows in an airplane which is following the identified vectors for approaching or departing a particular runway at an airport;

determining the size of the identified viewable individual planar surfaces;

maintaining a database of the individual surfaces so identified;

determining the size of the indicia required on each identified planar surfaces to render the indica viewable by passengers in the airplanes following the vector;

offering one or a combination of the individual identified planar surfaces suitable for advertiser indicia, to advertisers; and

placing advertiser indica on one or a combination of the surfaces determined to be of the proper size and viewing angle to render it readable by passengers in airplanes following the designated vector during approach or departure from an airport. Or, the steps might be changed to allow advertisers to provide their desired advertising copy and from that copy proper individual or multiple identified surfaces would be ascertained that would allow the provided copy to be read by the passengers in planes following the vectors in the area desired by the advertiser.

Identifying suitable planar surfaces for location of advertising indica can be accomplished by determining the normal descent and incline rates for different sized aircraft following the vectors to and from the airport and the size of indica required for an average human eye to discern at the varying altitudes. Then large planar rooftops, parking lots, and such can be individually identified as being at the proper viewing angle from one side or the opposite side of airplanes following the vectors and having a size sufficient for indica to be located thereon and discerned by viewing passengers in landing airplanes.

Once the individual planar surfaces at the proper viewing angles have been identified, they would be matched to advertiser indicia such that the reproduced indicia of the individual advertisers, when placed on the identified planar surfaces, is of sufficient size to be read by passengers viewing it through airliner cabin windows.

Potential advertisers would be able to advertise in very specific geographic regions based on the airport location. The services or products could be local in nature thereby providing passengers with local service and product availability. Or the advertisements could be national in scope such as car rental companies or hotel chains desiring name brand advertising on a national basis.

The indica may be imparted to the planar surface using direct application of paint or composite material to reproduce the indica desired at the size required for individual locations to be viewed at the viewing angle from the airplane. Or, the indica may be imparted to canvas, vinyl, or other signage material and mounted on or above the individual planar surfaces. Still further, electronic means for display of indicia such as LED driven large format displays can be employed to provide illuminated or moving advertisements, or changing pages of advertising indica on the identified planar surfaces. Whichever mode of reproduction of indica is employed, it must be of a size calculated to be legible by airline passengers looking at it, at the determined viewing angle from the airplane at the determined altitude and following the approach vector to the airport. Therefore identified planar areas further from the center line of the approach vector will need to be larger on average than those closer since the distance will make indica smaller and the viewing angle from the airplane window increases with the increase in distance from the approach vector of planes to the airport.

However, once so identified, each planar surface when matched to the advertiser indica and properly reproduced in a size for the indicia to be read or understood by passengers looking from the airplane window at the determined viewing angle, will be viewable by hundreds of thousands of passengers monthly in planes which must follow the assigned approach vectors to individual airports.

In this respect, before explaining at least one embodiment of the device and method herein in detail, it is to be understood that the invention is not limited in its application to the details of construction, and to the arrangement of the components or method steps set forth in the following description or illustrated in the drawings. The invention is thus capable of other embodiments and of being practiced and carried out in various ways and in different orders of execution. Also, it is to be understood that the phraseology and terminology employed herein are for the purpose of description and should not be regarded as limiting.

Still further, in another embodiment of the system and method herein, large planar areas viewable from space-based satellites and adjacent to popular local buildings or venues can be determined. In this mode of the method and system, remote internet users who seek a view of a popular geographic venue on their computer, would also see the large format indica of an advertisement positioned on the identified planar area adjacent to the venue requested. Many cities and states have venues that are more frequently viewed by Google Earth and such than other locales, and such could be determined by calculating the views requested by remote users of the service providing the satellite view. Once ascertained as a popular venue for satellite viewing, large planar areas viewable adjacent to the identified location can be ascertained and subsequently indica for advertising placed thereon.

Much like the airline passengers viewing through the windows of the plane following the assigned approach vectors will see advertising along the way, internet users requesting a satellite view of a popular venue will see adjacent advertising on rooftops or planar surfaces to that popular satellite viewed venue.

As such, those skilled in the art will appreciate that the conception upon which the method of identifying and selling Terrestrial large format advertisements is based may readily be utilized as a basis for the designing of other vests for carrying out the purposes of the present invention. It is important, therefore, that the claims be regarded as including such equivalent construction insofar as they do not depart from the spirit and scope of the present invention.

It is an object of this invention to provide a method of determining individual surfaces suitable for large format advertising indicia that are viewable by passengers in departing or landing aircraft following assigned vectors to and from an airport runway.

It is a further object of the invention to match such identified surfaces with advertiser indica to be located thereon, such that the indicia in letters or graphics is discernable by passengers in landing or departing planes from an altitude and angle the planes follow along an assigned vector.

A further object of this invention is the provision of such identified planar surfaces for large format advertising indica to advertisers desiring local geographic advertising.

Yet another object of this invention is the identification of planar surfaces that are located adjacent to buildings or venues, which are popularly requested for satellite viewing by internet users to situate advertising indica thereon.

These together with other objects and advantages which will become subsequently apparent reside in the details of the construction and method as more fully hereinafter described and claimed, reference being had to the accompanying drawings forming a part thereof, wherein like numerals refer to like parts throughout.

Yet another objection of this invention is the cataloging of the dimensional characteristics of individual planar surfaces located adjacent to vectors followed by aircraft approaching or leaving an airport runway and matching those dimensional characteristics to advertiser indica.

Yet a further object of this invention is the employment of demographics regarding passengers who use individual airports and matching the demographics of such passengers with advertiser's requests and with suitable individual planar surfaces suitable to the advertiser's indica to the targeted group of passengers.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

These together with other objects and advantages which will become subsequently apparent reside in the details of the construction and method as more fully hereinafter described and claimed, reference being had to the accompanying drawings forming a part thereof, wherein like numerals refer to like parts or steps throughout.

### BRIEF DESCRIPTION OF DRAWINGS

FIG. 1 depicts an example of indica on an identified planar surface that is viewable by a passenger in an airplane following a determined approach vector to a specific airport.

FIG. 2 is a flow chart for a preferred embodiment of the method of ascertaining individual planar surfaces based on approach vectors and altitudes at individual airport runways and viewing angles of passengers in planes following the vectors.

### DETAILED DESCRIPTION OF PREFERRED EMBODIMENTS

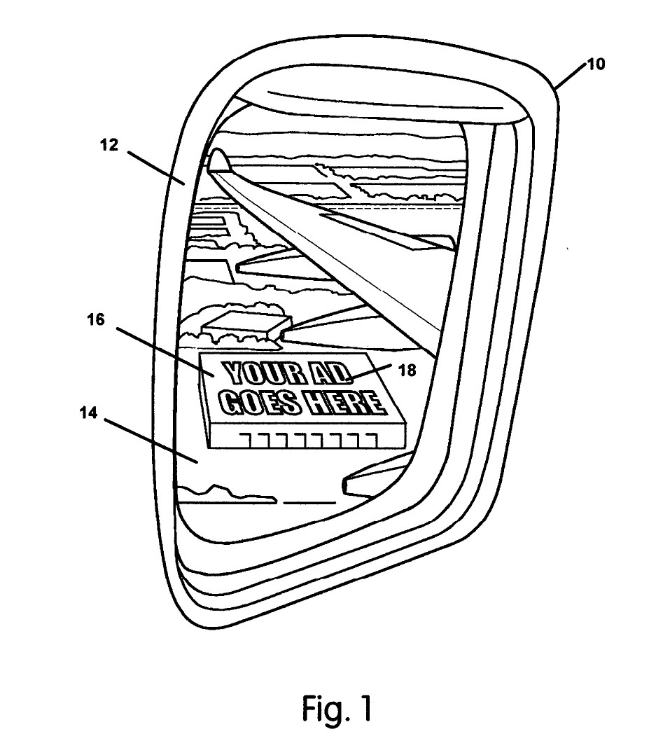

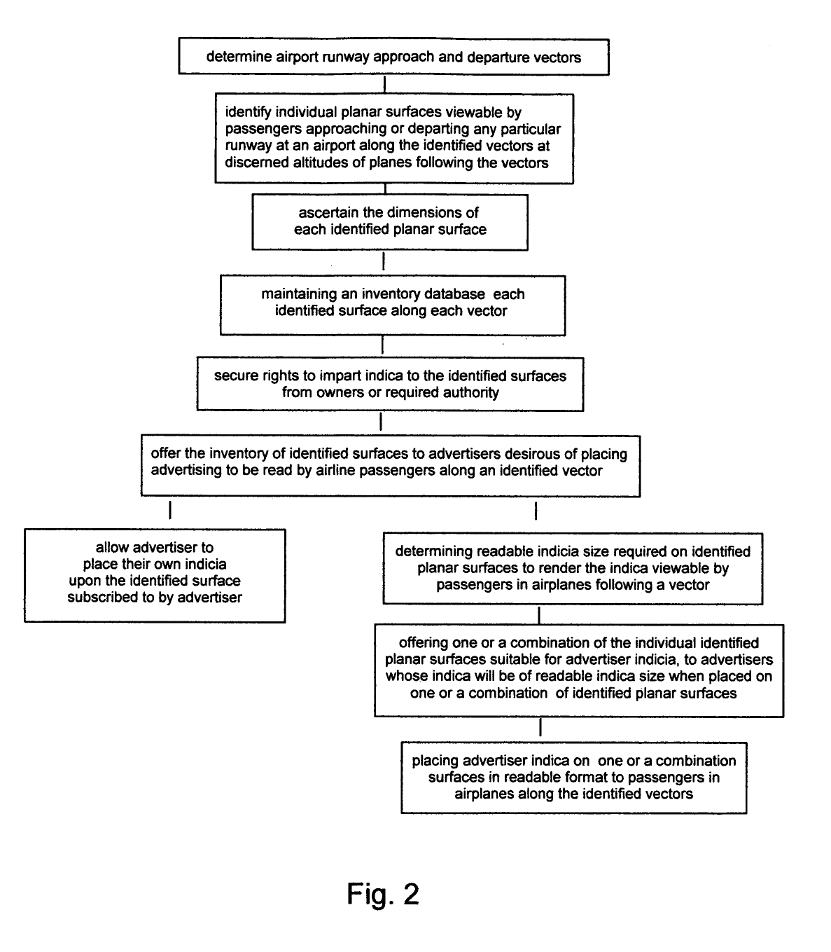

Referring now to the drawings, FIGS. 1-2 there is seen in FIG. 1, the typical passenger view 10 through an aircraft window 12 of the ground 14 during approach or departure from an airport runway, along an assigned or customary approach or departure vector, followed by aircraft using that airport's runway. As can be ascertained, at the proper viewing angle, larger planar surfaces 16 with indica 18 upon them are readable and viewable from the passenger seats along the identified vector at the different altitudes along the way. As the plane gets lower in altitude, the size of the indica 18 can be formed smaller and conversely as the airplane rises higher, the indica 18 must be larger to be readable by passengers in their seats throughout the aircraft windows 12.

In a method of identifying and offering such planar surfaces 16 herein disclosed as depicted in FIG. 2, in a first step, the assigned approach and departure vectors for individual runways at specific individual airports is determined. Once so determined, the individual planar surfaces 16 suitable for viewing by passengers from fuselage windows 12 in an airplane following descent and departure altitudes along the identified vectors for the associated airport, is identified either by a flyover with a plane, or a virtual flyover using satellite imaging and a computer and following the vector to and from the identified airport.

Since advertising indica 18 and other indica 18 must fit the dimensions of the available sized surfaces 16, in a next step, the dimensions of each of the identified viewable individual planar surfaces 16, along the vector associated with the identified airport, are determined. Since these dimensions must be matched to advertiser criteria for display of indica 18, once the dimensions of planar available surfaces 16 along the approach and departure vectors are ascertained, the respective dimensions are stored in a database of the individual planar surface locations and associated with their individual dimensions. Based on the respective locations along the approach and departure vectors, and respective dimensions, once the rights to place indica on the surfaces are obtained, they can be provided to advertisers based on the advertiser's requirements for planar surface 16 of sufficient dimensions to host their advertisement copy indicia 18, and subsequently the advertiser would themselves place that indica 18 on one or a plurality of identified planar surfaces 16 to appropriately hold the advertisement copy.

Or, if the advertiser wants the indica 16 appropriately placed for them, then the advertiser provided indica 18 would be examined for size, and then it would be determined what size that indicia 18 would be required for reproduction on identified planar surfaces 16 to render it readable by passengers viewing the indicia 18 on the planar surfaces 16 through aircraft windows 12 in airplanes following the respective vector path to and from the associated airport.

At this point the appropriate planar surfaces 16 would be offered singularly or in combination to the advertiser. Once subscribed to by the advertiser, either the advertiser would be allowed to place the indica 18, or it would be placed for the subscribing advertiser on one or a combination of the surfaces 16 determined to be of the proper size, and viewing angle, to render the advertisement indicia 18 readable by passengers looking through the windows 12 of airplanes following the specific airport's designated vectors during approach or departure from an airport.

The same procedure and options could be followed when offering the identified planar surfaces 16 to advertisers wishing to place indica 18 to be read by satellite mapping programs to be viewed by visitors to sites like Google Earth mapping.

Of course other steps or variances in steps of the method can be employed as would occur to those skilled in the art and are anticipated. However, the overriding factor in the method herein is the determination of approach and take-off vectors at specific airports for individual runways and the identification of useable planar surfaces which are viewable by passengers through aircraft windows traveling along those vectors and then offering or placing advertising upon the surfaces.

While all of the fundamental characteristics and features of the system and method for identifying and selling terrestrial large format advertising viewable by air travelers or remote internet users using satellite imaging have been disclosed and described, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A method of providing advertising space for indica to advertisers comprising the steps of:
identifying individual flight vectors for approaching and departing aircraft at individual airport runways;
identifying individual planar surfaces viewable by passengers from fuselage windows in an airplane which is following the identified vectors during approach or departure from the runway; and
offering information to advertisers about the individual planar surfaces which are suitable for viewing.

2. The method of claim 1 additionally including:
determining the size of the identified viewable individual planar surfaces;
maintaining a database of the individual surfaces so identified;

3. The method of claim 2 additionally comprising:
offering said planar surfaces to advertisers for display advertising and allowing the advertiser to impart their own indica to the surfaces subscribed to.

4. The method of claim 2 additionally comprising:
determining the size of the indicia required on each identified planar surfaces to render the indica viewable by passengers in the airplanes following the vector;
offering one or a combination of the individual identified planar surfaces suitable for advertiser indicia, to advertisers;
placing advertiser indica on one or a combination of the surfaces determined to be of the proper size and viewing angle to render it readable by passengers in airplanes following the designated vector during approach or departure from an airport.
